(19) United States
(12) Patent Application Publication
(10) Pub. No.: US 2009/0297237 A1
(43) Pub. Date: Dec. 3, 2009

(54) INDUCTION HEATING FIXING DEVICE AND IMAGE FORMING APPARATUS EMPLOYING INDUCTION HEATING FIXING DEVICE

(75) Inventors: Akira Shimatani, Osaka-shi (JP); Yoshihiro Tohnai, Osaka-shi (JP); Junya Yoda, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/475,945

(22) Filed: Jun. 1, 2009

(30) Foreign Application Priority Data
May 30, 2008 (JP) 2008-142659
Jun. 4, 2008 (JP) 2008-146670
Jun. 11, 2008 (JP) 2008-152408

(51) Int. Cl. G03G 15/20

(52) U.S. Cl. 399/329

(57) ABSTRACT

A fixing device comprises a heated member formed into a hollow, cylindrical shape, said heated member including a nonmagnetic portion having a particular length along an axial direction of said heated member, a magnetic flux generator for generating magnetic flux exerted on said heated member, a first magnetic core disposed face to face with said magnetic flux generator with said heated member positioned between said first magnetic core and said magnetic flux generator to form a magnetic circuit which is routed to come out of said magnetic flux generator, pass through said heated member and return to said magnetic flux generator, and a shifting mechanism for varying the length of an area of said heated member along the axial direction thereof where the nonmagnetic portion of said heated member and said first magnetic core face each other.

### BACKGROUND OF THE INVENTION

1. Field of the Invention

The present invention relates to a fixing device for fixing a toner image to a printing sheet by using an induction heating technique as well as to an image forming apparatus provided with an induction heating fixing device.

2. Description of the Related Art

An image forming apparatus, such as a printer, a copying machine, a facsimile machine or a hybrid apparatus thereof, sometimes employs an induction heating fixing device whose fixing roller is heated by electromagnetic induction. This kind of fixing device is provided with an induction coil disposed face to face with a maximum sheet passing area of the fixing roller which includes a magnetic member. Magnetic flux generated by flowing an alternating current through the induction coil is lead to the fixing roller, and the fixing roller is heated by eddy currents (induction currents) induced by the magnetic flux.

Generally, it is desirable for the induction heating fixing device to maintain a sheet passing area of the fixing roller where a printing sheet passes at a specific fixing temperature. Conventionally, however, the induction heating fixing device can develop a problem when feeding a small-sized printing sheet whose width is smaller than the maximum sheet passing area of the fixing roller. Specifically, non-sheet passing areas of the fixing roller typically located close to both ends thereof where the printing sheet does not pass are overheated if the fixing roller is so heated as to maintain the sheet passing area thereof at the specific fixing temperature. To overcome this problem, the prior art to which the present invention is directed discloses some arrangements which make it possible to vary the length of a heated portion of the fixing roller according to paper size.

For example, Japanese Unexamined Patent Publication No. 2005-308783 proposes a fixing device including a plurality of magnetic cores having different lengths which are made rotatable so that one of the magnetic cores face an induction coil. This arrangement makes it possible to vary the length of a heated portion of a heated member by changing the magnetic core placed face to face with the induction coil.

This fixing device however has a problem that a large number of magnetic cores having different lengths corresponding to different paper sizes are required to ensure that the fixing device can be adapted to various paper sizes. Also, even if the fixing device is provided with many different magnetic cores suited to standard paper sizes, it is impossible to adapt the fixing device to other settings, such as nonstandard paper sizes which may be arbitrarily defined by a user.

On the other hand, Japanese Patent No. 3624040 describes a fixing device which makes it possible to vary the length of a heated portion of a fixing roller by means of a magnetic flux shield which blocks magnetic flux generated by an induction coil and exerted on a fixing roller and thereby alters the width of a magnetic circuit formed between the induction coil and a magnetic core.

This fixing device however allows the user to determine whether the magnetic flux should be blocked by the magnetic flux shield or not, so that the fixing device can not be adapted to a plurality of different paper sizes. Although it may be possible to prepare a plurality of magnetic flux shields having different sizes suited to different paper sizes, this approach requires a complicated mechanical structure and is not sited to practical applications.

### SUMMARY OF THE INVENTION

In light of the foregoing, it is an object of the invention to provide a simple arrangement which makes it possible to adjust the length of that portion of a heated member which is heated by induction heating with a high degree of freedom.

According to one principal aspect of the invention, a fixing device comprises a heated member formed into a hollow, cylindrical shape, the heated member including a nonmagnetic portion having a particular length along an axial direction of the heated member, a magnetic flux generator for generating magnetic flux exerted on the heated member, a first magnetic core disposed face to face with the magnetic flux generator with the heated member positioned between the first magnetic core and the magnetic flux generator to form a magnetic circuit which is routed to come out of the magnetic flux generator, pass through the heated member and return to the magnetic flux generator, and a shifting mechanism for varying the length of an area of the heated member along the axial direction thereof where the nonmagnetic portion of the heated member and the first magnetic core face each other.

These and other objects, features and advantages of the invention will become more apparent upon reading the following detailed description along with the accompanying drawings.

### BRIEF DESCRIPTION OF THE DRAWINGS

FIG. 1 is a block diagram generally showing the configuration of a copying machine of the present invention;

FIG. 2 is a schematic cross-sectional diagram generally showing the configuration of a fixing device according to a first embodiment;

FIGS. 3A and 3B are schematic side views of the fixing device of FIG. 2;

FIGS. 4A and 4B are schematic side views of a fixing device in one variation of the first embodiment;

FIG. 5 is a schematic cross-sectional diagram generally showing the configuration of a fixing device according to a second embodiment;

FIG. 6 and 7 are schematic side views of the fixing device of FIG. 5;

FIGS. 8A, 8B and 8C are diagrams for explaining heating operation performed in the fixing device of the second embodiment, FIG. 8A showing a cross section taken along lines VIIIA-VIIIA of FIG. 7, FIG. 8B showing a cross section taken along lines VIIIB-VIIIB of FIG. 7, and FIG. 8C showing a cross section taken along lines VIIIC-VIIIC of FIG. 7;

FIGS. 9 to 12 are schematic side views of fixing devices according to variations of the second embodiment;

FIG. 13 is a schematic cross-sectional diagram generally showing the configuration of a fixing device according to a third embodiment;

FIG. 14 is a schematic side view of the fixing device of FIG. 13;

FIG. 15 is a diagram showing the construction of a fixing roller used in the third embodiment;

FIGS. 16A and 16B are cross-sectional diagrams for explaining a magnetic path formed in the fixing device of the third embodiment taken along lines XVIA-XVIA and XVIB-XVIB of FIG. 14, respectively;

FIGS. 17A, 17B, 17C and 17D are schematic diagrams for explaining the internal construction of the fixing roller of the third embodiment;

FIGS. 18A, 18B, 18C and 18D are schematic diagrams for explaining the internal construction of a fixing roller of a fixing device in one variation of the third embodiment; and

FIGS. 19A and 19B are cross-sectional diagrams for explaining a magnetic path formed in the fixing device of the variation of the third embodiment taken along lines XIXA-XIXA and XIXB-XIXB of FIG. 18D, respectively.

### DETAILED DESCRIPTION OF THE PREFERRED EMBODIMENTS

Preferred embodiments of the invention are now described specifically with reference to the drawings. It is to be understood that the embodiments discussed hereinafter are simply illustrative and are not intended in any sense to limit the technical scope of the present invention.

### First Embodiment

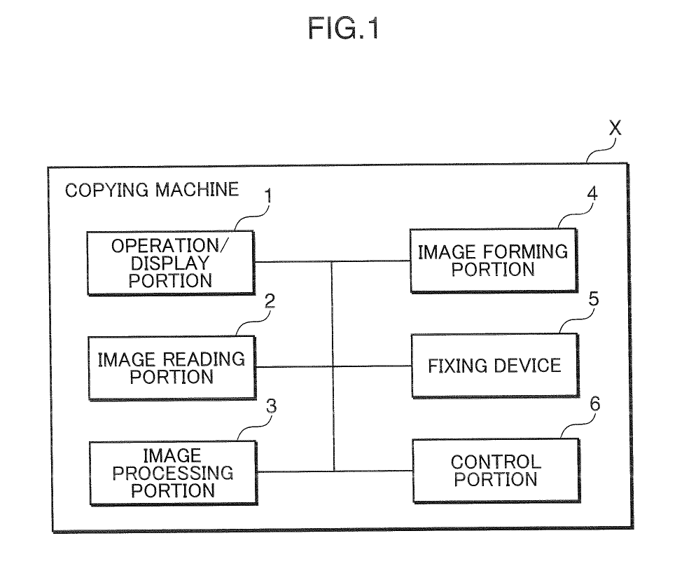

FIG. 1 is a block diagram generally showing the configuration of a copying machine X of the present invention. The copying machine X according to a first embodiment of the invention is now is described with reference to FIG. 1.

The copying machine X comprises an operation/display portion 1, an image reading portion 2, an image processing portion 3, an image forming portion 4, a fixing device 5 and a control portion 6. The copying machine X also comprises various other constituent elements that are commonly used in a copying machine designed to perform image forming operation by electrophotographic technology. These constituent elements are conventional and are not described in this specification. It is to be noted that the invention is not limited to the copying machine but can also be implemented in other kinds of electrophotographic image forming apparatuses, such as a printer, a facsimile machine, as well as a hybrid apparatus designed to provide functions of these apparatuses and a scanner.

The control portion 6 includes a central processing unit (CPU) and peripheral components, such as a read-only memory (ROM), a random access memory (RAM). The control portion 6 carries out operation to provide overall control of the copying machine X according to a particular program stored in the ROM.

The operation/display portion 1 includes a liquid crystal display (LCD) which presents various kinds of information according to instructions from the control portion 6 and a touch panel which permits a user to enter various commands to the control portion 6. The image reading portion 2 performs operation for optically reading an image of an original placed on an original platen or set in an automatic document feeder (ADF). Image data read by the image reading portion 2 is sent to the image processing portion 3.

The image processing portion 3 performs various kinds of image processing operations on the image data read by the image reading portion 2 or on original image data entered from an external information processing apparatus through a communications network like local area network (LAN). The original image data which has gone through the image processing operations performed by the image processing portion 3 is delivered to the image forming portion 4 which includes a photosensitive drum, a charging unit, a development unit and an exposure unit. The image forming portion 4 forms a toner image by supplying toner (developing agent) according to the original image data inputted from the image processing portion 3 and transfers the toner image to a printing sheet.

The fixing device 5 fuses the toner image transferred to the printing sheet by the image forming portion 4 and thereby fixes the toner image to the printing sheet. The copying machine X of the present embodiment is characterized by the configuration and working of the fixing device 5 as will be described in detail hereinbelow.

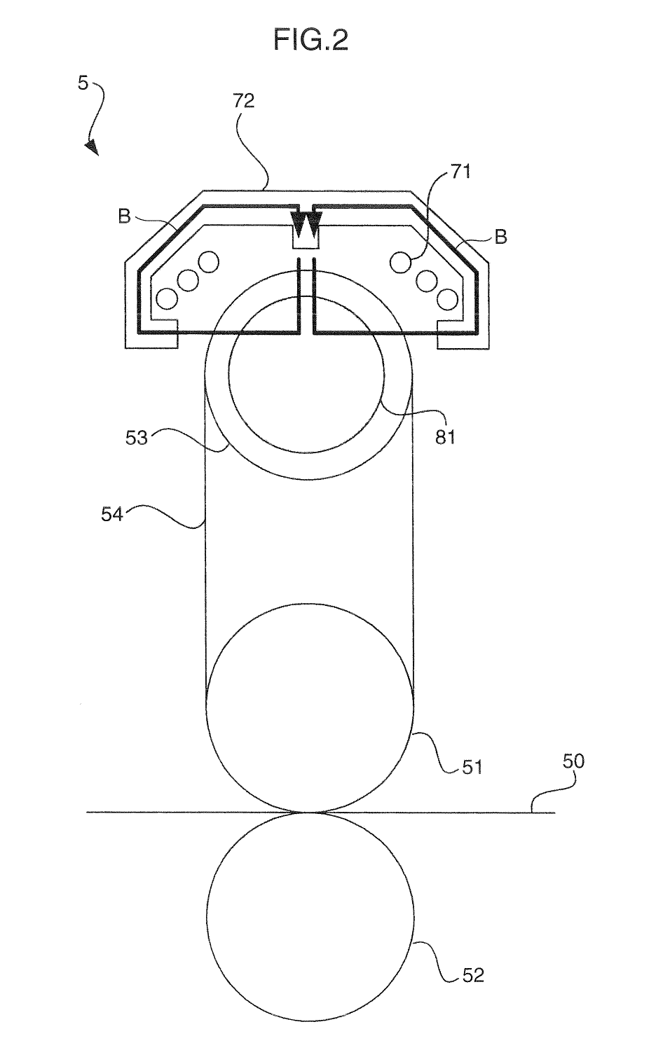

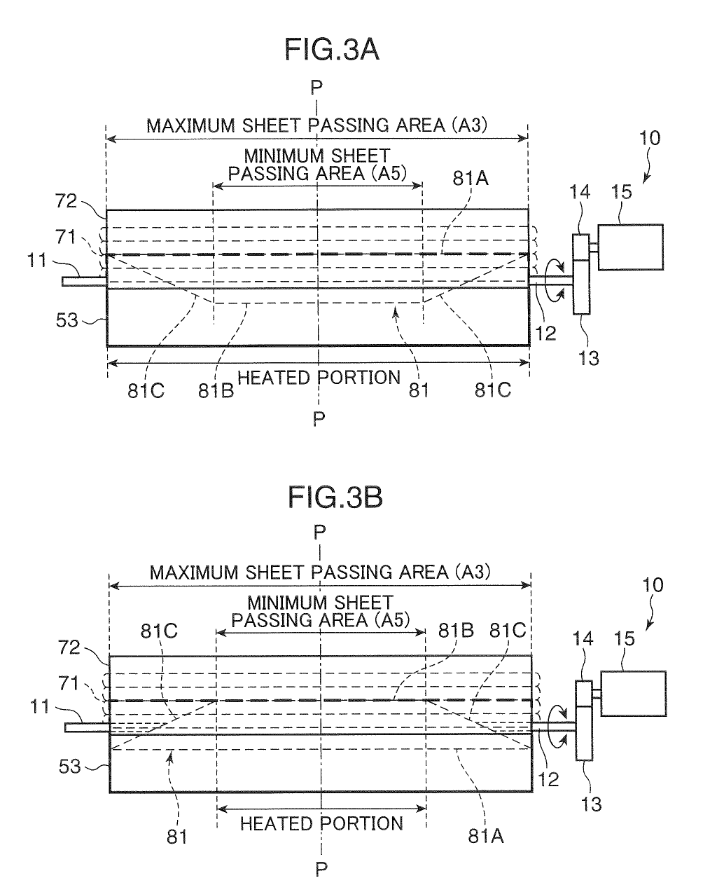

FIG. 2 is a schematic cross-sectional diagram generally showing the configuration of the fixing device 5 according to the first embodiment, and FIGS. 3A and 3B are fragmentary schematic diagrams of a heating roller 53 of the fixing device 5 as viewed along a sheet passing direction, FIG. 3A showing a state of the fixing device 5 in which a maximum sheet passing area (overall length) of the heating roller 53 is heated and FIG. 3B showing a state of the fixing device 5 in which a minimum sheet passing area (part of the length) of the heating roller 53 is heated. As referred to in the present. Specification, the maximum sheet passing area means a maximum width of a printing sheet (as measured in a width direction perpendicular to a sheet feeding direction) passed through the fixing device 5 and the minimum sheet passing area means a minimum width of a printing sheet passed through the fixing device 5.

The fixing device 5 includes a fixing roller 51 and a pressure roller 52 which are pressed against each other together forming a fixing nip portion in between. As the printing sheet carrying the toner image transferred thereto is fed along a paper path 50, the printing sheet is nipped at the fixing nip portion formed between the rotating fixing roller 51 (actually a fixing belt 54) and the pressure roller 52 and transported further in a downstream direction. During this sheet transport process, heat is applied to the printing sheet at the fixing nip portion so that the toner image transferred to the printing sheet is fixed thereto.

The fixing device 5 further includes the aforementioned heating roller 53 (heated member) having approximately the same length as the fixing roller 51, the fixing belt 54 which is a nonmagnetic member mounted between the fixing roller 51 and the heating roller 53, an induction coil 71 (magnetic flux generator) for generating magnetic flux (magnetic field) by flowing an alternating current, an outer core 72 (second magnetic core) and an inner core 81 (first magnetic core) which together form a magnetic path (magnetic circuit) for guiding the magnetic flux generated by the induction coil 71, and a core turning mechanism 10 (rotary driver) for rotatably supporting the inner core 81.

The heating roller 53 is a hollow, cylindrical member made of a nonmagnetic material like stainless steel (SUS). The inner core 81 which is fitted in an internal space of the heating roller 53 is a rodlike member made of a ferromagnetic material like ferrite. The outer core 72 is also a member made of a ferromagnetic material like ferrite. The inner core 81 is mounted to face the induction coil 71 with cylindrical outer wall surface of the heating roller 53 located in between, and the outer core 72 is disposed on the outside of the induction coil 71.

In this fixing device 5, the outer core 72 and the inner core 81 mounted face to face with each other together form the magnetic path (shown by arrows B in FIG. 2) passing through the cylindrical outer wall surface of the heating roller 53, and the magnetic flux generated by the induction coil 71 is routed along this magnetic path. As the magnetic flux intersects the cylindrical outer wall surface of the heating roller 53, eddy currents are induced on the heating roller 53. The heating roller 53 is heated by Joule heat produced by the eddy currents. As the heating roller 53 is heated in this fashion, the fixing belt 54 mounted on the heating roller 53 is also heated.

The copying machine X performs image forming operation (print job) using printing sheets which may have various paper sizes. Therefore, a sheet passing area on the fixing belt 54 of the fixing device 5, that is, an area where a printing sheet passing through the aforementioned fixing nip portion goes into contact with the fixing belt 54, can vary. In the fixing device 5 of this embodiment, the printing sheet is transported along the paper path 50 in such a manner that a center line of the printing sheet passing through the center of the width thereof passes through the center of the length of the fixing roller 51 (shown by straight lines P-P in FIGS. 3A and 3B).

More specifically, the copying machine X forms an image on printing sheets of various sizes ranging from the A5 size which is a minimum paper size (corresponding to the minimum sheet passing area) to the A3 size which is a maximum paper size (corresponding to the maximum sheet passing area). The heating roller 53 has the length corresponding to the maximum paper size. The fixing belt 54 provides a sheet passing width which can vary from the width of the A5 size corresponding to the minimum sheet passing area (approximately 150 mm wide) to the width of the A3 size corresponding to the maximum sheet passing area (approximately 300 mm wide).

Here, an assumption if made that the heating roller 53 is heated over the entirety of the length of the heating roller 53 so as to heat the fixing belt 54 over an entire area thereof regardless of the paper size. If it is intended to maintain the sheet passing area of the fixing belt 54, that is, an area of the fixing belt 54 where heat is taken away by the printing sheet, at a specific fixing temperature in this case, both end portions of the heating roller 53 corresponding to non-sheet passing areas of the fixing belt 54 may potentially be overheated. Therefore, if the printing sheet passed through the fixing nip portion has a size smaller than the A3 size corresponding to the maximum sheet passing area, it is preferable to limit a heated portion of the heating roller 53 to the width of the actual sheet passing area that corresponds to the paper size of the printing sheet.

In the fixing device 5 of the first embodiment, there is made an arrangement for adjusting the length of the heated portion of the heating roller 53 by turning the inner core 81 about an axis thereof by means of the core turning mechanism 10 (shifting mechanism). This feature of the embodiment is described in great detail in the following.

The induction coil 71 is an air-core coil formed by winding a wire all across the maximum sheet passing area on the cylindrical outer wall surface of the heating roller 53 along an axial direction thereof without using a metal core. The induction coil 71 is located outside the heating roller 53 at a position separated by a predefined distance from the cylindrical outer wall surface of the heating roller 53, wherein the predefined distance is a distance considered as being suitable for forming the magnetic path between a combination of the induction coil 71 and the outer core 72 and the inner core 81. In one variation of the embodiment, the induction coil 71 may be made of a plurality of induction coils which are arranged side by side along a longitudinal direction of the heating roller 53 to cover the entirety of the maximum sheet passing area.

The outer core 72 has a generally U-shaped cross section as viewed along a rotational axis direction of the heating roller 53 so that the outer core 72 covers part of the heating roller 53 in a circumferential direction thereof as depicted in the cross-sectional diagram of FIG. 2. The outer core 72 is located to face the maximum sheet passing area on the heating roller 53. The induction coil 71 is located within a U-shaped space bounded by the outer core 72.

The outer core 72 is so disposed as to form the magnetic path along which the magnetic flux generated by the induction coil 71 passes through the cylindrical outer wall surface of the heating roller 53, goes across the inner core 81 and passes again through the cylindrical outer wall surface of the heating roller 53 as shown by arrows B in FIG. 2. In another variation of the embodiment, the outer core 72 may be made of a plurality of magnetic core elements which are magnetically coupled to one another. As the outer core 72 is disposed as mentioned above, the magnetic path is formed in such a way that the magnetic flux generated by the induction coil 71 acts on the heating roller 53 and the heating roller 53 is heated by induction heating.

On the other hand, the inner core 81 is so mounted inside the heating roller 53 as to face the maximum sheet passing area on the cylindrical outer wall surface of the heating roller 53. The inner core 81 contributes to forming part of the magnetic path along which the magnetic flux generated by the induction coil 71 and guided by the outer core 72 passes through the surface of the heating roller 53 and returns to the outer core 72 after passing again through the surface of the heating roller 53. The inner core 81 is supported rotatably about the axis thereof.

The core turning mechanism 10 is for driving the inner core 81 to rotate independently of the heating roller 53. The core turning mechanism 10 includes rotary shafts 11, 12 connected to both ends of the inner core 81, wheel gears 13, 14 connected to the rotary shaft 12 and a driving motor 15, such as a stepping motor, connected to the wheel gear 14. The rotary shaft 11 is supported by a housing (not shown) of the fixing device 5 or by a housing (not shown) of the copying machine X.

The inner core 81 is a cylindrical member having a first portion 81A which has a length corresponding to the maximum sheet passing area (A3) along the axial direction and a second portion 81B which has a length corresponding to the minimum sheet passing area (A5) along the axial direction. The inner core 81 further has a pair of intermediate portions 81C between the first portion 81A and the second portion 81B, and the distance along the axial direction between the two intermediate portions 81C continuously changes. The inner core 81 thus structured has a shape obtained by obliquely cutting away both end portions of a cylindrical body. Thus, the inner core 81 has a generally trapezoidal shape in side view as seen along the circumferential direction of the heating roller 53 as shown in FIGS. 3A and 3B.

As the inner core 81 is caused to rotate about the axis thereof by the core turning mechanism 10, an effective facing length (i.e., the width within which the magnetic path can be formed) between the heating roller 53 and the inner core 81 varies. Specifically, the core turning mechanism 10 causes the inner core 81 to rotate to take a first posture at which the first portion 81A of the inner core 81 faces the heating roller 53, a second position at which the second posture 81B of the inner core 81 faces the heating roller 53, or a third posture at which part of the inner core 81 between particular points of the intermediate portions 81C faces the heating roller 53. The amount of rotation (rotating angle) of the inner core 81 is controlled by the control portion 6 (serving as a rotating angle controller) shown in FIG. 1.

The above-described configuration makes it possible to continuously vary the length of a portion of the inner core 81 facing the induction coil 71 and the outer core 72 (that is, the portion of the inner core 81 closest to the induction coil 71 and the outer core 72) between the width of the A3 size corresponding to the maximum sheet passing area on the heating roller 53 and the width of the A5 size corresponding to the minimum sheet passing area on the heating roller 53 as a result of rotation of the inner core 81. Thus, it is possible to vary the width of the magnetic path along the axial direction formed between the inner core 81 and the combination of the induction coil 71 and the outer core 72 by altering the rotating angle of the inner core 81. This also makes it possible to vary the width of the magnetic flux passing through the cylindrical outer wall surface of the heating roller 53 along the longitudinal direction thereof.

When the control portion 6 actuates the driving motor 15, the inner core 81 is driven to rotate about the axis thereof by a turning force transmitted through the wheel gears 14, 13. The control portion 6 controllably drives the driving motor 15 to alter the amount of rotation of the inner core 81, making it possible to adjust the width of the magnetic path along the axial direction formed between the inner core 81 and the combination of the induction coil 71 and the outer core 72, or the length of the heated portion of the heating roller 53.

In actuality, the control portion 6 controls the amount of rotation of the inner core 81 according to the paper size of each printing sheet fed into the fixing device 5. It is to be noted that the embodiment may be modified such that a control circuit (not shown) provided in the fixing device 5 is used instead of the control portion 6 for altering the amount of rotation of the inner core 81.

If the printing sheet used is the A4 size, for example, the control portion 6 causes the inner core 81 to rotate such that the width of a facing area between the combination of the induction coil 71 and the outer core 72 and the inner core 81, or the width of an area within which the magnetic flux generated by the induction coil 71 acts on the inner core 81, matches the width of the A4 size printing sheet. The control portion 6 detects the paper size based on set data concerning printing sheets used for a print job to be performed by the copying machine X and the type of a paper cassette used, for instance. A relationship between various paper sizes which may be used and the amount of rotation of the inner core 81 determined by the core turning mechanism 10, such as the amount of driving (e.g., the number of stepping pulses or driving time) of the driving motor 15 for turning the inner core 81 up to a position appropriate for the specified paper size, is stored in advance in the ROM in the control portion 6. In one variation of the embodiment, there may be provided a sensor for detecting an angular position of the inner core 81 so that the amount of rotation of the inner core 81 is controlled by a sensing signal fed back from the sensor.

When the angular position of the inner core 81 is set at the position appropriate for the specified paper size, an alternating current is flowed through the induction coil 71. As a result, the heating roller 53 is heated by induction heating only within the area corresponding to the width of the A4 size printing sheet. It is therefore possible to prevent overheating of the end portions of the heating roller 53 corresponding to the non-sheet passing areas of the fixing belt 54. In this case, the magnetic flux generated by the induction coil 71 passes through the fixing belt 54 as well so that the fixing belt 54 made of a nonmagnetic material is also heated directly.

As thus far explained, the fixing device 5 of the first embodiment makes it possible to vary the width of the magnetic path formed in the fixing device 5 by turning the inner core 81 by means of the core turning mechanism 10. This means that it is possible to arbitrarily vary the length of the heated portion of the heating roller 53 between the maximum sheet passing area and the minimum sheet passing area shown in FIGS. 3A and 3B. Therefore, the present embodiment provides a high degree of freedom in adjusting the length of the heated portion of the heating roller 53, so that the length of the heated portion of the heating roller 53 can be adjusted to suit any paper size arbitrarily selected by the user, for example.

The configuration of the first embodiment thus far described is an illustrative example in which the heating roller 53 supporting the fixing belt 54 mounted thereon is heated by induction heating. If the fixing device 5 is of a type employing no fixing belt 54, for example, the aforementioned configuration may be so modified as to dispose the inner core 81 within the fixing roller 51 to directly heat the fixing roller 51 which goes into direct contact with the printing sheet.

Also, the foregoing first embodiment has been described with reference to an example in which the center line of the printing sheet passes through the center of the length of the heating roller 53 (shown by straight lines P-P in FIGS. 3A and 3B). In one variation of the embodiment, the printing sheet may be fed in such a manner that one lateral end of the printing sheet passes along one axial end of the heating roller 53.

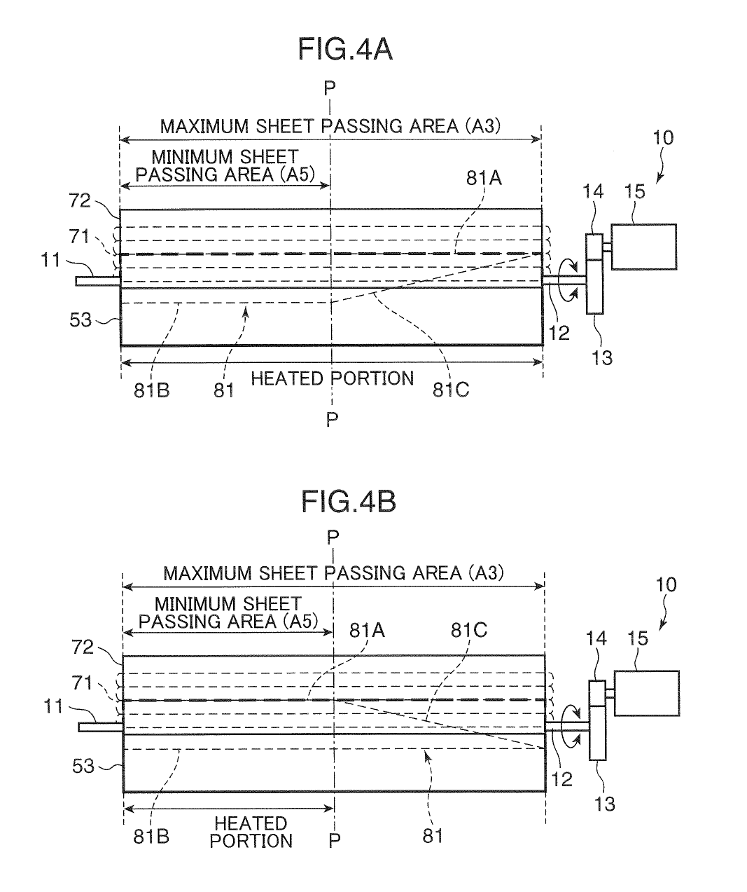

FIGS. 4A and 4B are schematic side views of a fixing device in this kind of variation of the first embodiment. An inner core 81 of this variation has a shape obtained by obliquely cutting away one end portion of a cylindrical body. The inner core 81 thus structured has a first portion 81A having a length corresponding to the maximum sheet passing area (A3), a second portion 81B having a length corresponding to the minimum sheet passing area (A5) and an intermediate portion 81C. Both the first portion 81A and the second portion 81B extend from a first end of the heating roller 53 toward a second end thereof, and the intermediate portion 81C is located close to the second end of the heating roller 53 only.

In this modified configuration of the first embodiment, the length of a portion of the inner core 81 facing the induction coil 71 and the outer core 72 measured from the first end of the heating roller 53 varies as the core turning mechanism 10 drives the inner core 81 to rotate. This makes it possible to continuously vary the length of the heated portion of the heating roller 53 between the maximum sheet passing area and the minimum sheet passing area shown in FIGS. 4A and 4B.

### Second Embodiment

The foregoing first embodiment has described an illustrative example in which the inner core 81 is rotated by the core turning mechanism 10 which serves as the shifting mechanism for varying the length of a longitudinal portion of the inner core 81 facing the cylindrical outer wall surface of the heating roller 53, or the length of the heated portion thereof. A second embodiment of the invention described hereunder is an example in which a thrust driver is used as a shifting mechanism for moving at least one of an induction coil 71 and an inner core 281 along an axial direction thereof.

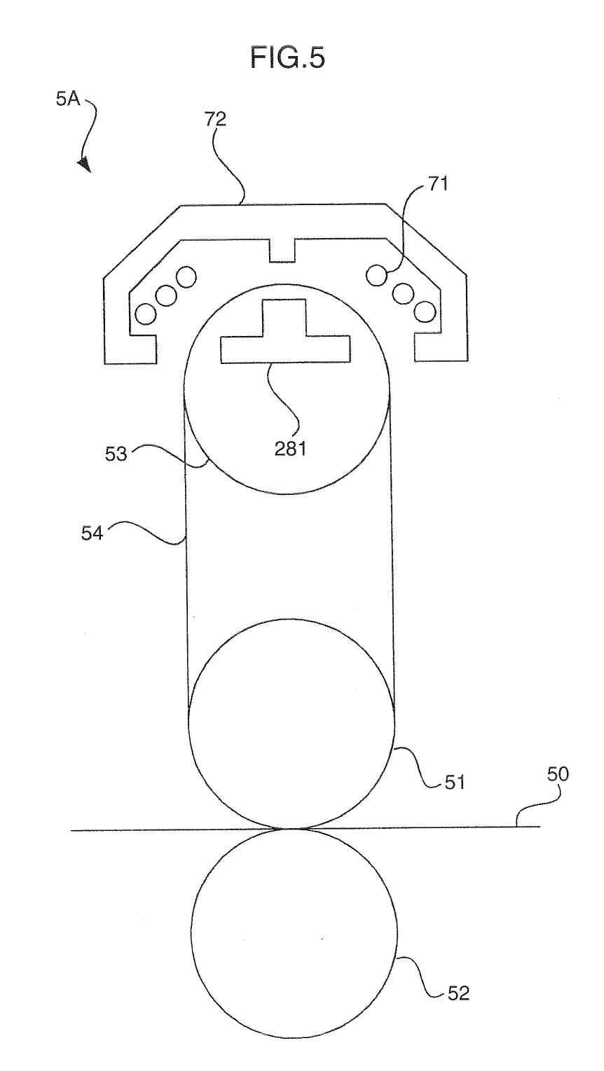

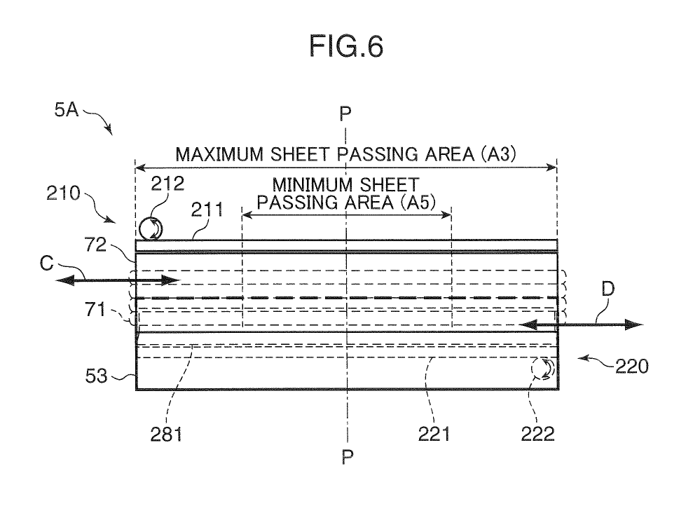

FIG. 5 is a schematic cross-sectional diagram generally showing the configuration of a fixing device 5A according to the second embodiment, and FIG. 6 is a fragmentary schematic diagram of the fixing device 5A as viewed along a sheet passing direction thereof. In these Figures, elements identical or similar to those of the first embodiment are designated by the same reference symbols and a description of such elements is simplified or not given below.

The fixing device 5A includes a fixing roller 51, a pressure roller 52, a heating roller 53 (heated member) having approximately the same length as the fixing roller 51, a fixing belt 54 which made of a nonmagnetic member mounted between the fixing roller 51 and the heating roller 53, the aforementioned induction coil 71 for generating magnetic flux by flowing an alternating current, an outer core 72 (second magnetic core) for forming a magnetic path (magnetic circuit) for guiding the magnetic flux generated by the induction coil 71 and the aforementioned inner core 281 (first magnetic core). The fixing device 5A further includes an outer core moving mechanism 210 (constituting one part of the thrust driver) for movably supporting the outer core 72 (induction coil 71) and an inner core moving mechanism 220 (constituting another part of the thrust driver) for movably supporting the inner core 281.

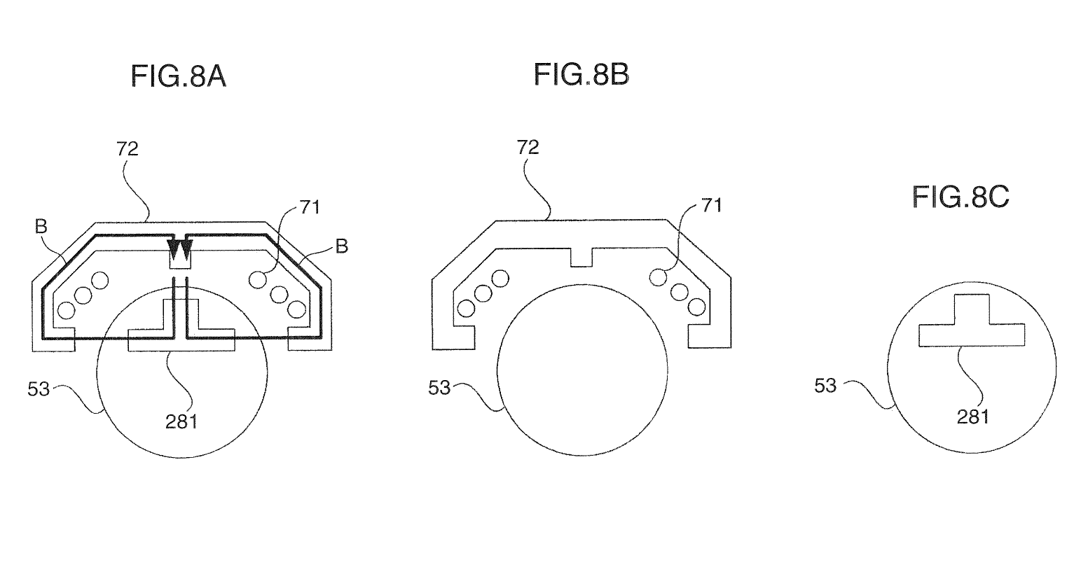

In this fixing device 5A, the outer core 72 and the inner core 281 mounted face to face with each other together form the magnetic path (shown by arrows B in FIG. 8A) passing through the cylindrical outer wall surface of the heating roller 53, and the magnetic flux generated by the induction coil 71 passes along this magnetic path. As the magnetic flux intersects the cylindrical outer wall surface of the heating roller 53, eddy currents are induced on the heating roller 53. The heating roller 53 is heated by Joule heat produced by the eddy currents. As the heating roller 53 is heated in this fashion, the fixing belt 54 mounted on the heating roller 53 is also heated.

In the fixing device 5A of the second embodiment, the length of the heated portion of the heating roller 53 is adjusted by moving a combination of the induction coil 71 and the outer core 72 and/or the inner core 281 by the outer core moving mechanism 210 and/or the inner core moving mechanism 220 in a thrust direction (axial direction). This feature of the embodiment is described in great detail in the following.

While the induction coil 71 is an air-core coil formed by winding a wire all across the maximum sheet passing area as in the first embodiment, the induction coil 71 of the second embodiment is supported by the outer core 72. Thus, when the outer core 72 is moved, the induction coil 71 moves in the same way as the outer core 72.

The induction coil 71 and the outer core 72 are supported by the outer core moving mechanism 210 movably along the axial direction of the heating roller 53. As shown in FIG. 6, the outer core moving mechanism 210 includes a rack 211 supporting the induction coil 71 and the outer core 72 and a pinion 212 meshed with the rack 211. The rack 211 is supported by an unillustrated rail member movably along the axial direction (shown by arrows C in FIG. 6) of the heating roller 53, and the pinion 212 is connected to a driving motor (not shown), such as a stepping motor.

In the outer core moving mechanism 210 thus configured, the aforementioned driving motor is driven under the control of the control portion 6 (serving as a moving distance controller) shown in FIG. 1 to rotate the pinion 212, causing the rack 211 to move in linear sliding motion. The sliding motion of the rack 211 causes the induction coil 71 and the outer core 72 to move together along the axial direction of the heating roller 53.

The inner core 281 is mounted inside the heating roller 53 face to face with the induction coil 71 and the outer core 72 so that the cylindrical outer wall surface of the heating roller 53 is located between the inner core 281 and the combination of the induction coil 71 and the outer core 72 as illustrated in FIG. 5. The inner core 281 is generally T-shaped in cross section and has a length corresponding to the maximum sheet passing area on the heating roller 53. This means that the induction coil 71, the outer core 72 and the inner core 281 of the fixing device 5A have generally the same length. The inner core 281 serves to form that part of the magnetic path which returns the magnetic flux generated by the induction coil 71 and led into the heating roller 53 back to the outer core 72 after passing through the cylindrical outer wall surface of the heating roller 53 (refer to FIG. 8A).

The inner core 281 is supported by the inner core moving mechanism 220 movably along the axial direction of the heating roller 53 like the induction coil 71 and the outer core 72. The inner core moving mechanism 220 includes a rack 221 supporting the inner core 281 and a pinion 222 meshed with the rack 221 as shown in FIG. 6. The rack 221 is supported by an unillustrated rail member movably along the axial direction (shown by arrows D in FIG. 6) of the heating roller 53, and the pinion 222 is connected to a driving motor (not shown), such as a stepping motor.

In the inner core moving mechanism 220 thus configured, the aforementioned driving motor is driven under the control of the control portion 6 (serving as the moving distance controller) shown in FIG. 1 to rotate the pinion 222, causing the rack 221 to move in linear sliding motion. The sliding motion of the rack 221 causes the inner core 281 to move along the axial direction of the heating roller 53.

The fixing device 5A thus configured can vary the length of a portion of the inner core 281 facing the induction coil 71 and the outer core 72 by the aforementioned working of the outer core moving mechanism 210 and the inner core moving mechanism 220. This makes it possible to adjust the length of the heated portion of the heating roller 53.

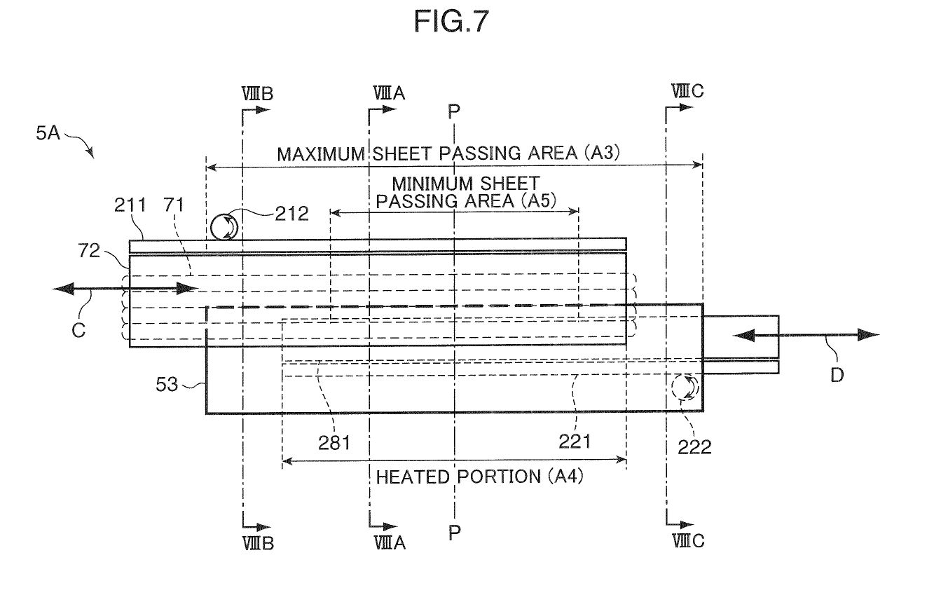

Referring now to FIGS. 7, 8A, 8B and 8C, operation for heating the heating roller 53 is explained by using an example in which an A4 size printing sheet whose width is smaller than the maximum sheet passing area (A3) of the fixing device 5A but larger than the minimum sheet passing area (A5) thereof is passed through the fixing device 5A. When the A4 size printing sheet is used, it is preferable to limit the length of the heated portion of the heating roller 53 to the width of the A4 size printing sheet as shown in FIG. 7.

In this case, the control portion 6 controls the combination of the induction coil 71 and the outer core 72 and the inner core 281 to move by a specified distance in directions of arrows C and D shown in FIG. 7 by the outer core moving mechanism 210 and the inner core moving mechanism 220 in accordance with the size of the printing sheet (A4 in this example) passed through the fixing device 5A. Specifically, the control portion 6 controllably drives the driving motors (not shown) provided individually in the outer core moving mechanism 210 and the inner core moving mechanism 220 to turn by predetermined amounts, thereby causing the pinions 212, 222 to rotate.

In this example, the pinion 212 is caused to turn in such a direction that the induction coil 71 and the outer core 72 move in a leftward direction (as illustrated) from the center of the length of the heating roller 53 (shown by a straight line P-P in FIG. 7). On the other hand, the pinion 222 is caused to turn in such a direction that the inner core 281 moves in a rightward direction (as illustrated) from the center of the length of the heating roller 53. When the pinions 212, 222 are caused to turn in such directions, the length of the portion of the inner core 281 facing the induction coil 71 and the outer core 72 gradually decreases.

Here, the combination of the induction coil 71 and the outer core 72 and the inner core 281 are controlled to move by the same distance in opposite directions symmetrically with respect to the straight line P-P shown in FIG. 7. The combination of the induction coil 71 and the outer core 72 and the inner core 281 are kept moving up to a point where the length of the portion of the inner core 281 facing the induction coil 71 and the outer core 72 becomes equal to the width of the A4 size printing sheet.

When the combination of the induction coil 71 and the outer core 72 and the inner core 281 have moved to positions corresponding to the width of the A4 size printing sheet, an alternating current is flowed through the induction coil 71. As a result, the heating roller 53 is heated by induction heating only within an area corresponding to the width of the A4 size printing sheet. In this case, the magnetic flux generated by the induction coil 71 passes through the fixing belt 54 as well so that the fixing belt 54 made of a nonmagnetic material is also heated directly.

FIGS. 8A, 8B and 8C are diagrams for explaining heating operation performed in the fixing device 5A of the second embodiment, FIG. 8A showing a cross section taken along lines VIIIA-VIIIA of FIG. 7, FIG. 8B showing a cross section taken along lines VIIIB-VIIIB of FIG. 7, and FIG. 8C showing a cross section taken along lines VIIIC-VIIIC of FIG. 7.

As shown in FIG. 8A, the magnetic flux generated by the induction coil 71 is guided along part of the magnetic path formed between the outer core 72 and the inner core 281 in an area of the heating roller 53 where the induction coil 71 and the outer core 72 face the inner core 281 (refer to arrows B in FIG. 8A). Therefore, the cylindrical outer wall surface of the heating roller 53 located in the magnetic path is heated by Joule heat produced by eddy currents induced by passage of the magnetic flux.

By comparison, in an area of the heating roller 53 where the induction coil 71 and the outer core 72 are not positioned to face the inner core 281, there is formed no magnetic path along which the magnetic flux generated by the induction coil 71 passes through the heating roller 53 as shown in FIGS. 8B and 8C. Thus, this portion of the heating roller 53 is not heated.

As thus far described, the fixing device 5A of the second embodiment is provided with the shifting mechanism including the outer core moving mechanism 210 and the inner core moving mechanism 220 for moving the combination of the induction coil 71 and the outer core 72 and the inner core 281, respectively, along the axial direction of the heating roller 53. This arrangement of the embodiment makes it possible to arbitrarily vary the length of the heated portion of the heating roller 53. Therefore, the present embodiment provides a high degree of freedom in adjusting the length of the heated portion of the heating roller 53, so that the length of the heated portion of the heating roller 53 can be adjusted to suit any paper size arbitrarily set by the user, for example.

Some variations of the second embodiment are now described in the following. The foregoing second embodiment has been described, by way of example, with reference to a typical configuration in which the induction coil 71 and the outer core 72 are mounted outside the heating roller 53 and the inner core 281 is mounted inside the heating roller 53. This configuration may be modified in such a way that the induction coil 71 is provided inside the heating roller 53. In this case, the induction coil 71 is supported movably along the axial direction of the heating roller 53 by the inner core moving mechanism 220, for example, so that the width of an area where the induction coil 71 and the inner core 281 face the outer core 72 can be varied.

Also, the second embodiment has been described with reference to a configuration in which the heating roller 53 on which the fixing belt 54 is mounted is heated. If the fixing device 5A is of a type employing no fixing belt 54, the aforementioned configuration may be so modified as to directly heat the fixing roller 51 which goes into direct contact with the printing sheet.

Further, the foregoing second embodiment has been described with reference to a configuration in which the outer core moving mechanism 210 and the inner core moving mechanism 220 are separately provided. This configuration may be modified such that the outer core moving mechanism 210 and the inner core moving mechanism 220 are combined into a single mechanism which performs functions of both the outer and inner core moving mechanisms 210, 220 to vary the width of an area where the induction coil 71 and the outer core 72 face the inner core 281. Specifically, this combined mechanism includes a single driving motor whose driving force is transmitted to the aforementioned pinions 212, 222 to move the respective racks 211, 221 by the same distance in opposite directions symmetrically with respect to the center of the length of the heating roller 53 so that the two racks 211, 221 are moved away from each other.

This modified configuration also makes it possible to easily vary the length of the heated portion of the heating roller 53 by controllably driving the single driving motor to adjust the width of the area where the induction coil 71 and the outer core 72 face the inner core 281. The aforementioned single moving mechanism can be devised by using various kinds of transfer mechanisms which are conventionally known.

Additionally, the second embodiment has been described with reference to an illustrative example in which both the combination of the induction coil 71 and the outer core 72 and the inner core 281 are moved. This configuration may be so modified as to vary the heated portion of the heating roller 53 by varying relative positions of the induction coil 71, the outer core 72, the inner core 81 and the heating roller 53

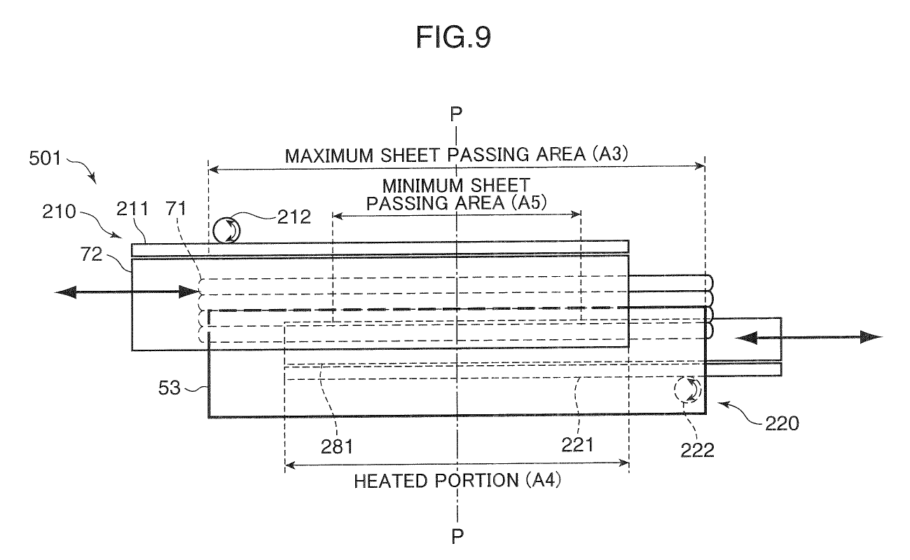

FIG. 9 is a schematic diagram showing a fixing device 501 in one variation of the second embodiment. This fixing device 501 is configured such that the outer core moving mechanism 210 supports the outer core 72 movably along the axial direction of the heating roller 53 and the inner core moving mechanism 220 supports the inner core 281 movably along the axial direction of the heating roller 53. On the other hand, the induction coil 71 is held at a fixed position by an unillustrated stationary supporting member so that the entirety of the induction coil 71 along a longitudinal direction thereof is positioned face to face with an entire portion of the heating roller 53.

In the fixing device 501 thus configured, only the outer core 72 and the inner core 281 are moved by the outer core moving mechanism 210 and the inner core moving mechanism 220, respectively. As the outer core 72 and the inner core 281 are moved, the width of an area where the outer core 72 and the inner core 281 face each other varies, making it possible to adjust the length of the heated portion of the heating roller 53 with respect to the center of the length of the heating roller 53 (shown by a straight line P-P in FIG. 9).

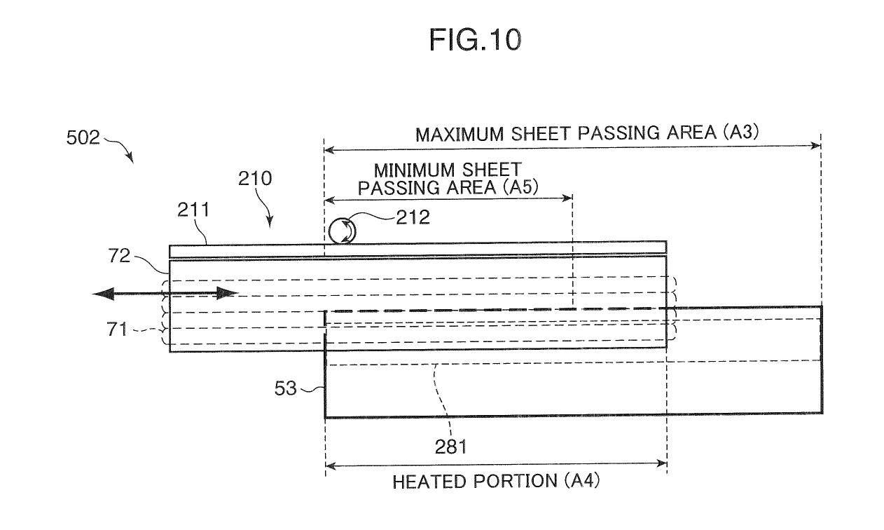

FIG. 10 is a schematic diagram showing a fixing device 502 in another variation of the second embodiment. Employing the above-described basic configuration of the second embodiment, this fixing device 502 is configured such that one lateral end of the printing sheet passes along one axial end of the heating roller 53. In this variation, the outer core moving mechanism 210 supports the induction coil 71 and the outer core 72 movably along the axial direction of the heating roller 53. The fixing device 502 is not provided with the inner core moving mechanism 220 so that the inner core 281 can not be moved along the axial direction of the heating roller 53 from a specific position where the inner core 281 is mounted.

In the fixing device 502 thus configured, the induction coil 71 and the outer core 72 are moved by the outer core moving mechanism 210. Consequently, the width of an area where the induction coil 71 and the outer core 72 face the heating roller 53 and the inner core 281 varies, making it possible to adjust the length of the heated portion of the heating roller 53 with respect to one end of the heating roller 53.

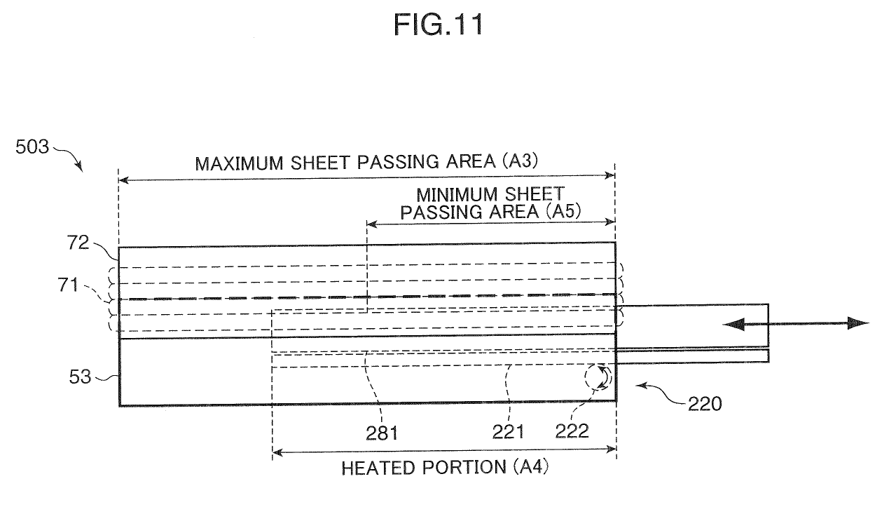

FIG. 11 is a schematic diagram showing a fixing device 503 in still another variation of the second embodiment. Like the above-described fixing device 502, this fixing device 503 is configured such that one lateral end of the printing sheet passes along one axial end of the heating roller 53.

The fixing device 503 of this variation is, so to say, a reverse version of the aforementioned fixing device 502. Specifically, the inner core moving mechanism 220 supports the inner core 281 movably along the axial direction of the heating roller 53. The fixing device 503 is not provided with the outer core moving mechanism 210 so that the induction coil 71 and the outer core 72 can not be moved along the axial direction of the heating roller 53 from specific positions where the induction coil 71 and the outer core 72 are mounted.

In the fixing device 503 thus configured, the inner core 281 is moved by the inner core moving mechanism 220. Consequently, the width of an area where the induction coil 71 and the outer core 72 face the inner core 281 varies, making it possible to adjust the length of the heated portion of the heating roller 53 with respect to one end of the heating roller 53.

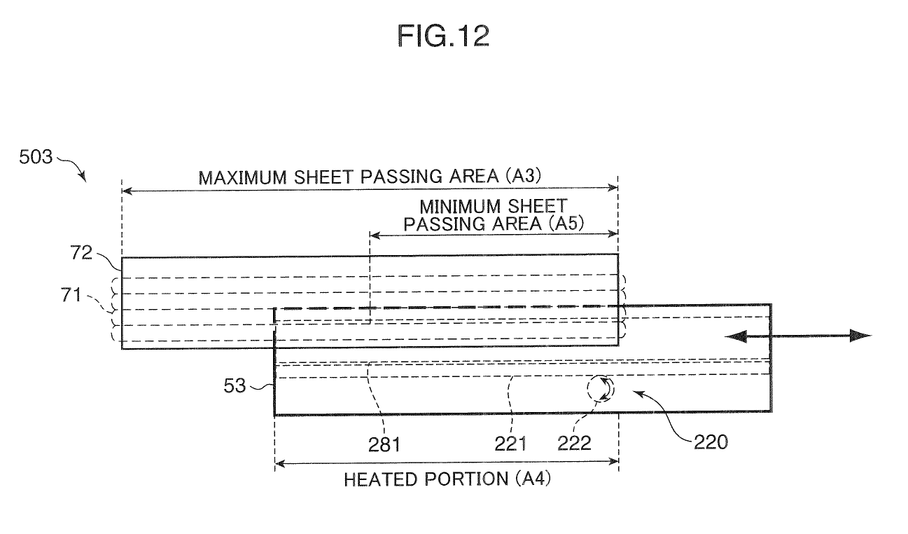

Furthermore, as shown in FIG.12, the fixing device 503 may be configured such that the inner core moving mechanism 220 supports the heating roller 53 and the inner core 281 movably along the axial direction of the heating roller 53. In this case, the inner core moving mechanism 220 moves the heating roller 53 and the inner core 281 together, making it possible to adjust the length of the heated portion of the heating roller 53 with respect to one end of either the induction coil 71 or the outer core 72.

### Third Embodiment

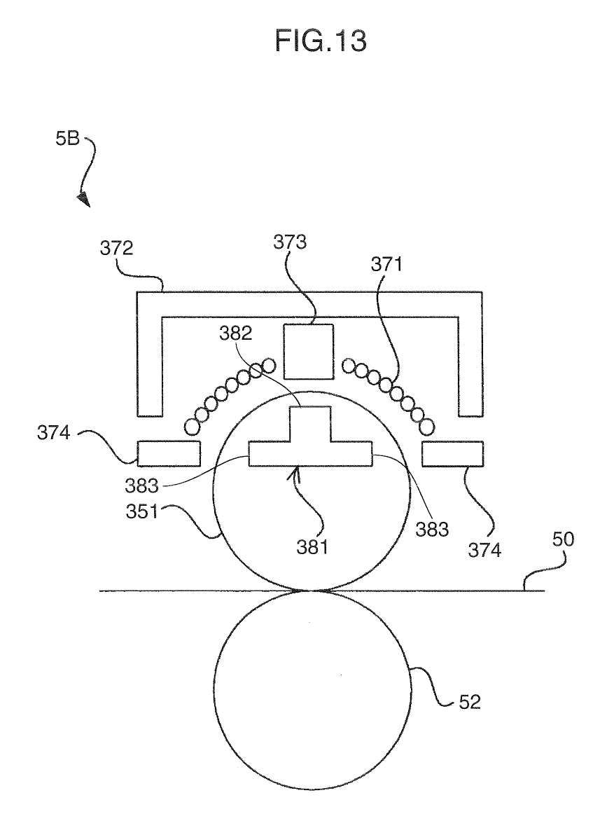

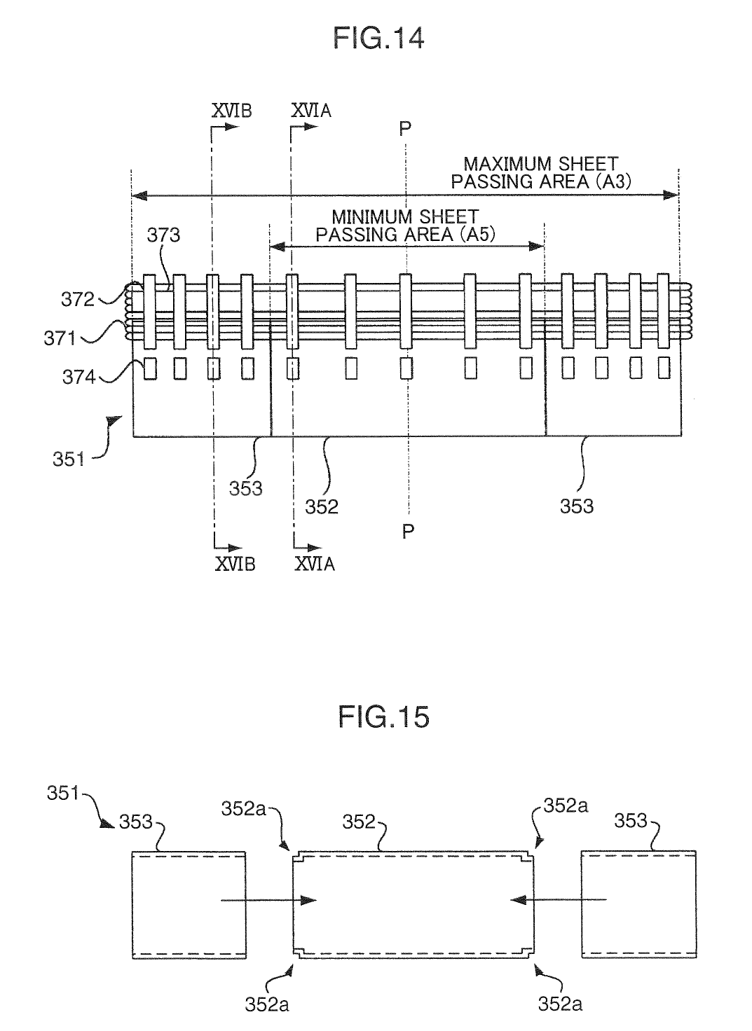

FIG. 13 is a schematic cross-sectional diagram generally showing the configuration of a fixing device 5B according to a third embodiment, and FIG. 14 is a schematic side view of the fixing device 5B. The foregoing first and second embodiments described heretofore are examples in which the fixing device 5 (5A) includes a combination of the heating roller 53 and the fixing belt 54, the heating roller 53 serving as a heated member. The third embodiment described hereunder is an example in which the fixing device 5B does not employ the combination of the heating roller 53 and the fixing belt 54 but includes a fixing roller 351 and a pressure roller 52 which are pressed against each other together forming a fixing nip portion in between, wherein the fixing roller 351 serves as a heated member. A main feature of the third embodiment is that the fixing device 5B is provided with the fixing roller 351 having magnetic and nonmagnetic portions.

As shown in FIG. 13, the fixing device 5B includes the aforementioned fixing roller 351 and pressure roller 52 which together form the fixing nip portion in between, an induction coil 371 for generating magnetic flux by flowing an alternating current, first to third outer core sections 372, 373, 374 and an inner core 381 which together form a magnetic path (magnetic circuit) for guiding the magnetic flux generated by the induction coil 371. The outer core sections 372, 373, 374 and the inner core 381 are members made of a ferromagnetic material like ferrite. The induction coil 371 and the outer core sections 372, 373, 374 are fixed at specific positions by an unillustrated supporting member. The inner core 381 is supported by a later-described core moving mechanism movably along an axial direction of the fixing roller 351.

As in the foregoing embodiments, printing sheets which may be passed through the fixing device 5B are of various sizes ranging from the A5 size which is the minimum paper size (corresponding to the minimum sheet passing area as wide as approximately 150 mm) to the A3 size which is the maximum paper size (corresponding to the maximum sheet passing area as wide as approximately 300 mm). The printing sheets which may be passed through the fixing device 5B can have other paper sizes, such as B5, A4 and B4. The printing sheet is transported along the paper path 50 in such a manner that the center line of the printing sheet passes through the center of the length of the fixing roller 351 (shown by a straight line P-P shown in FIG. 14). Needless to say, the printing sheet may be fed in such a manner that one lateral end of the printing sheet passes along one end of the fixing roller 351.

The fixing roller 351 (heated member) is a hollow, cylindrical member which includes a magnetic roller element 352 (magnetic portion) whose length along the axial direction corresponds to the width of the minimum sheet passing area (first width) and a pair of nonmagnetic roller elements 353 (nonmagnetic portions) joined to both axial ends of the magnetic roller element 352 as shown in FIG. 14. When the two nonmagnetic roller elements 353 are joined to the magnetic roller element 352, the fixing roller 351 has an overall length along the axial direction corresponding to the width of the maximum sheet passing area. Thus, the two nonmagnetic roller elements 353 have a total length corresponds to the difference between the widths of the maximum and minimum sheet passing areas. This total length of the two nonmagnetic roller elements 353 is hereinafter referred to as a second width. The fixing roller 351 thus configured is rotatably supported independently of the inner core 381.

The magnetic roller element 352 may be made of a magnetic material like iron while the nonmagnetic roller elements 353 may be made of a nonmagnetic material like stainless steel (SUS). While the magnetic roller element 352 may have any length at least smaller than the width of the maximum sheet passing area, it is preferable that the magnetic roller element 352 have a length corresponding to the width of the minimum sheet passing area in order that the fixing roller 351 can be adapted to as many paper sizes as possible.

Given below is one specific example of the magnetic roller element 352 and the nonmagnetic roller elements 353. The magnetic roller element 352 is an iron roller element having a length of 150 mm, a diameter of 40 mm, a thickness of 0.6 mm, a resistivity of 9.71⁻⁸ Ω·m, a relative permeability of 100 H/m, a specific heat of 444 J/kg·K, a thermal conductivity of 84 W/m·K, a density of 7860 kg·m³. Each of the nonmagnetic roller elements 353 is a SUS stainless steel roller element having a length of 75 mm, a diameter of 40 mm, a thickness of 0.6 mm, a resistivity of 72.0e⁻⁸ Ω·m, a relative permeability of 1.01 H/m, a specific heat of 492 J/kg·K, a thermal conductivity of 16.7 W/m·K, a density of 7790 kg·m³.

The magnetic roller element 352 and the two nonmagnetic roller elements 353 must be joined together in such a manner that hollows or protrusions are not formed on a cylindrical outer surface of the fixing roller 351 which is configured by joining these roller elements 352, 353. This can be accomplished by shaping the magnetic roller element 352 and the nonmagnetic roller elements 353 in various ways. For example, there may be formed mating grooves 352a at both axial ends of the magnetic roller element 352 so that the two nonmagnetic roller elements 353 can be fitted thereto as can be seen from FIG. 15. The fixing roller 351 can be made by fitting the two nonmagnetic roller elements 353 on the mating grooves 352a to thereby join the magnetic roller element 352 and the two nonmagnetic roller elements 353. The present embodiment is not limited to this arrangement for joining the magnetic roller element 352 and the two nonmagnetic roller elements 353 but various other appropriate arrangements are available for joining the three roller elements 352, 353.

As shown in FIGS. 13 and 14, the induction coil 371 is an air-core coil formed by winding a wire all across the maximum sheet passing area on the cylindrical outer surface of the fixing roller 351 along the axial direction thereof. The fixing roller 351 and the induction coil 371 are located face to face with each other at positions separated by a predefined distance, wherein the predefined distance is a distance considered as being suitable for forming the magnetic path between the fixing roller 351 and the inner core 381. In one variation of the embodiment, the induction coil 371 may be made of a plurality of induction coils which are arranged side by side along a longitudinal direction of the fixing roller 351 so that the induction coil 371 covers all the length of the fixing roller 351.

The induction coil 371 generates the magnetic flux when an alternating current is supplied into the induction coil 371. The magnetic flux is guided to the fixing roller 351 by the outer core sections 372, 373, 374. The magnetic flux passing through the cylindrical outer surface of the fixing roller 351 produces induction currents (eddy currents) thereon, thereby heating the fixing roller 351 by induction heating. Since the fixing roller 351 rotates during operation, the fixing roller 351 is heated to a uniform temperature all along a circumferential direction.

The aforementioned first to third outer core sections 372, 373, 374 together form an outer core (second magnetic core) of the fixing device 5B of the third embodiment. As shown in FIG. 13, the first outer core section 372 has a generally U-shaped cross section including a portion located above the fixing roller 351. The first outer core section 372 includes a plurality of core segments which are located at specific intervals all across the maximum sheet passing area on the fixing roller 351 as depicted in FIG. 14.

The second outer core section 373 is located just above a longitudinal axis of the fixing roller 351 in a space unoccupied by the induction coil 371 at a middle part thereof as illustrated (FIG. 13). The second outer core section 373 is a single elongate member having a length corresponding to the width of the maximum sheet passing area on the fixing roller 351.

The third outer core section 374 also includes a plurality of core segments which are arranged in two rows on both sides of the fixing roller 351. The core segments of the third outer core section 374 are located at positions corresponding to the core segments of the first outer core section 372 along the longitudinal direction of the fixing roller 351 as can be seen from FIG. 14.

The first to third outer core sections 372, 373, 374 thus configured together form part of the magnetic path along which the magnetic flux passes through the surface of the fixing roller 351, or part of the magnetic path along which the magnetic flux passes through the cylindrical outer wall surface of the fixing roller 351, the inner core 381 and again the cylindrical outer wall surface of the fixing roller 351. It is to be noted that the outer core sections 372, 373, 374 may be integrated to form a single structure or divided into yet smaller segments (by further segmenting the first outer core section 372, for instance).

The inner core 381 (first magnetic core) includes a pair of core segments corresponding individually to the two nonmagnetic roller elements 353. Each core segment of the inner core 381 has such a length that is equal to the distance from one end of the magnetic roller element 352 (i.e., one end of the minimum sheet passing area) to a corresponding end of the maximum sheet passing area, that is, the length of each nonmagnetic roller element 353.

The inner core 381 is mounted inside the fixing roller 351 face to face with the induction coil 371 and the first to third outer core sections 372, 373, 374 so that the cylindrical outer wall surface of the fixing roller 351 is located between the inner core 381 and a group of the induction coil 371 and the outer core sections 372, 373, 374. The inner core 381 is generally T-shaped in cross section as viewed along an axial direction thereof as shown in FIG. 13. Each core segment of the inner core 381 has a first projecting portion 382 extending toward the second outer core section 373 and a pair of second projecting portions 383 extending toward the two rows of the core segments of the third outer core section 374.

With this arrangement, the magnetic flux generated by the induction coil 371 is guided along the magnetic path (magnetic circuit) so as to pass along the first outer core section 372 and the second outer core section 373, through the cylindrical outer wall surface of the fixing roller 351, the inner core 381 and again through the cylindrical outer wall surface of the fixing roller 351 and return to the third outer core section 374 and then to the first outer core section 372. In actuality, the magnetic flux generated by the induction coil 371 does not pass through the magnetic roller element 352 of the fixing roller 351 but through the nonmagnetic roller elements 353 thereof.

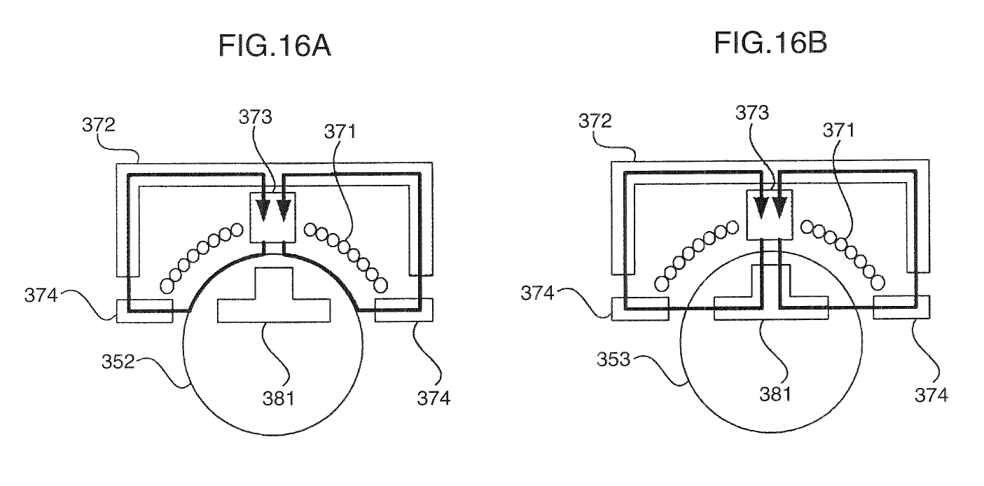

FIGS. 16A and 16B are cross-sectional diagrams for explaining the magnetic path formed in the fixing device 5B taken along lines XVIA-XVIA and XVIB-XVIB of FIG. 14, respectively. FIG. 16B shows a state in which the inner core 381 is located inside the individual nonmagnetic roller elements 353.

In an area where the magnetic roller element 352 of the fixing roller 351 exists, the magnetic flux generated by the induction coil 371 is guided from the second outer core section 373 along the surface of the fixing roller 351 and led to the third outer core section 374 as shown in FIG. 16A. As a result, the magnetic flux generated by the induction coil 371 produces induction currents (eddy currents) on the magnetic roller element 352 by electromagnetic induction so that the magnetic roller element 352 is heated.

By comparison, in areas where the nonmagnetic roller elements 353 of the fixing roller 351 exist, the magnetic flux generated by the induction coil 371 is guided from the second outer core section 373 to pass through the cylindrical outer wall surface of the fixing roller 351 as shown in FIG. 16B. The magnetic flux which has passed through the cylindrical outer wall surface of the fixing roller 351 is guided to pass across the core segments of the inner core 381 disposed inside the nonmagnetic roller elements 353, pass again through the cylindrical outer wall surface of the fixing roller 351 and return to the third outer core section 374. As a result, the magnetic flux generated by the induction coil 371 produces eddy currents on the nonmagnetic roller elements 353 in portions thereof where the magnetic flux intersects the nonmagnetic roller elements 353, thereby heating the nonmagnetic roller elements 353. The magnetic path is not formed between the second outer core section 373 and the third outer core section 374 in areas of the nonmagnetic roller elements 353 where no core segments of the inner core 381 exist therewithin, so that these areas of the nonmagnetic roller elements 353 are not acted upon by the magnetic flux, and thus not heated.

Accordingly, the minimum sheet passing area on the fixing roller 351 corresponding to the length of the magnetic roller element 352 is continuously heated. Outside the minimum sheet passing area, however, the fixing roller 351 is heated only in areas where the core segments of the inner core 381 disposed inside the fixing roller 351 face the nonmagnetic roller elements 353. Configured to use the aforementioned working, the fixing device 5B of the third embodiment adjusts the length of a heated portion of the fixing roller 351 by moving the inner core 381 by the below-described core moving mechanism.

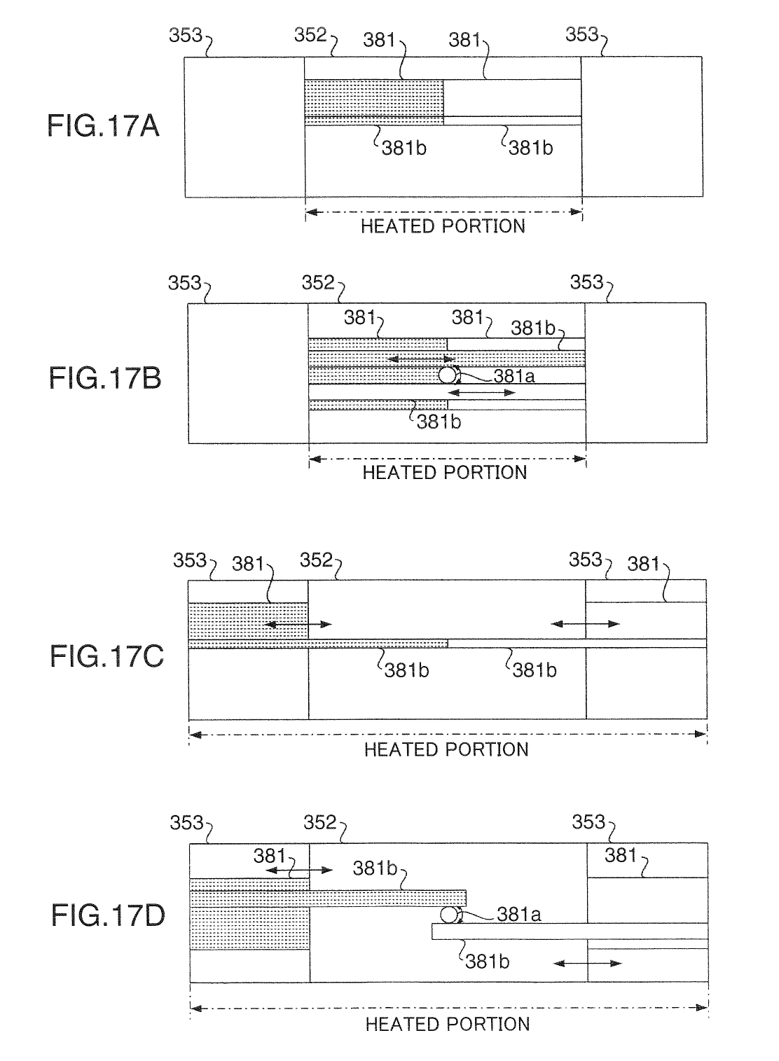

The core moving mechanism of the third embodiment for moving the inner core 381 along the axial direction of the fixing roller 351 is now described with reference to FIGS. 17A, 17B, 17C and 17D, wherein FIGS. 17A and 17B show a state in which the heated portion of the fixing roller 351 is adjusted to match the minimum sheet passing area, and FIGS. 17C and 17D show a state in which the heated portion of the fixing roller 351 is adjusted to match the maximum sheet passing area. FIGS. 17A and 17C are diagrams showing the internal construction of the fixing roller 351 as viewed along a sheet passing direction of the fixing roller 351, and FIGS. 17B and 17D are diagrams showing the internal construction of the fixing roller 351 as viewed vertically upward.

Inside the fixing roller 351, there are provided the two core segments of the inner core 381, each core segment having the same axial length (approximately 75 mm) as the nonmagnetic roller element 353. For ease of understanding, one of the core segments of the inner core 381 and associated elements thereof are shown by halftone dots in FIGS. 17A, 17B, 17C and 17D.

The individual core segments of the inner core 381 are supported by the core moving mechanism which includes a driving motor (not shown) such as a stepping motor, a pinion 381a connected to the driving motor, a pair of racks 381b meshed with the pinion 381a on both sides thereof and rail members (not shown) supporting the two racks 381b slidably along the axial direction of the fixing roller 351.

In this core moving mechanism, the driving motor is driven under the control of the control portion 6 shown in FIG. 1 to rotate the pinion 381a, causing the two racks 381b to move along the respective rail members. As a result, the two core segments of the inner core 381 supported by the respective racks 381b move in linear sliding motion along the axial direction of the fixing roller 351. It is therefore possible to arbitrarily vary the width of areas where the two nonmagnetic roller elements 353 face the respective core segments of the inner core 381. In this embodiment, a relationship between the amount of driving (e.g., the number of stepping pulses) of the driving motor and a moving distance of each core segment of the inner core 381 is predetermined. Incidentally, it is preferable to provide means (e.g., optical sensors) for detecting the position of each core segment of the inner core 381.

In the fixing device 5B thus configured, the magnetic path along which the magnetic flux generated by the induction coil 371 is guided is formed within a limited range corresponding to the length of the magnetic roller element 352 when the two core segments of the inner core 381 are retracted into the magnetic roller element 352 as shown in FIGS. 17A and 17B. In this case, the heated portion of the fixing roller 351 is set to the width of the minimum sheet passing area which corresponds to the length of the magnetic roller element 352 so that the nonmagnetic roller elements 353 at both axial ends of the magnetic roller element 352 are not are not heated.

On the other hand, when the two core segments of the inner core 381 are shifted to extend axially outward from the magnetic roller element 352 into the respective nonmagnetic roller elements 353 as shown in FIGS. 17C and 17D, the magnetic path along which the magnetic flux generated by the induction coil 371 is guided is formed not only in the aforementioned range corresponding to the length of the magnetic roller element 352 but also in the areas where the two nonmagnetic roller elements 353 face the respective core segments of the inner core 381. In this case (FIGS. 17C and 17D), the core segments of the inner core 381 exist in the entire areas (lengths) of the nonmagnetic roller elements 353 so that the heated portion of the fixing roller 351 is set to the width of the maximum sheet passing area which corresponds to the overall length of the fixing roller 351 including the magnetic roller element 352 and the two nonmagnetic roller elements 353.

In the copying machine X employing the fixing device 5B of the third embodiment, the control portion 6 controllably drives the above-described core moving mechanism according to the paper size of each printing sheet fed into the fixing device 5B. Therefore, it is possible to arbitrarily vary locations of the two core segments of the inner core 381 between the state shown in FIGS. 17A and 17B in which the heated portion of the fixing roller 351 matches the width of the minimum sheet passing area and the state shown in FIGS. 17C and 17D in which the heated portion of the fixing roller 351 matches the width of the maximum sheet passing area.

Specifically, the control portion 6 controls the core moving mechanism to move the inner core 381 in such a manner that at least one of the magnetic roller element 352 and the inner core 381 is located in a longitudinal area of the fixing roller 351 where the printing sheet of any particular paper size used in a print job passes and the inner core 381 is not located outside the width of that paper size.

The fixing device 5B of the third embodiment thus configured makes it possible to prevent overheating of end portions of the fixing roller 351 when the printing sheet passed through the fixing device 5B is smaller than the maximum paper size by varying the width of areas where the two core segments of the inner core 381 face the respective nonmagnetic roller elements 353 (nonmagnetic portions) according to the paper size to thereby adjust the heated portion of the fixing roller 351. In particular, the length of the heated portion of the fixing roller 351 can be varied by adjusting the moving distance of each core segment of the inner core 381 along the axial direction of the fixing roller 351. Therefore, the present embodiment provides a high degree of freedom in adjusting the length of the heated portion of the fixing roller 351, so that the length of the heated portion of the fixing roller 351 can be adjusted to suit any paper size arbitrarily set by the user, for example.

In addition, it is possible to adjust the length of the heated portion of the fixing roller 351 by positioning the core segments of the inner core 381 to face the magnetic roller element 352 when the nonmagnetic roller elements 353 are not to be heated and positioning the core segments of the inner core 381 to extend axially outward from both axial ends of the magnetic roller element 352 into the respective nonmagnetic roller elements 353 when the nonmagnetic roller elements 353 are to be heated. This adjustment can be accomplished without increasing the size of the fixing device 5B in the longitudinal direction of the fixing roller 351.

As mentioned in the foregoing embodiments, the fixing device 5B may be modified such that one lateral end of the printing sheet passes along one axial end of the fixing roller 351. In this variation of the third embodiment, the nonmagnetic roller element 353 is joined to only one axial end of the magnetic roller element 352, so that the length of the heated portion of the fixing roller 351 can be adjusted by varying the amount of projection of the inner core 381 from the magnetic roller element 352 into the nonmagnetic roller element 353 provided at one axial end of the fixing roller 351 by a core moving mechanism.

Also, the fixing device 5B may be modified such that the induction coil 371 is provided inside the fixing roller 351 and magnetic cores structured in the same way as the outer core sections 372, 373, 374 are disposed movably along the axial direction of the fixing roller 351. In this variation of the third embodiment, the magnetic cores are to be supported in such a manner that the amount of projection of each magnetic core from the magnetic roller element 352 into the pertinent nonmagnetic roller element 353 can be varied, making it possible to adjust the length of the heated portion of the fixing roller 351.

One possibility of the fixing device 5B of the third embodiment is that if ends of an area where the group of the induction coil 371 and the outer core sections 372, 373, 374 faces the inner core 381 are located inside the maximum sheet passing area, the magnetic flux generated by the induction coil 371 may leak from outside the inner core 381 through regions between each end of the inner core 381 and a corresponding end of the maximum sheet passing area. Part of the magnetic flux leaking through these regions may undesirably heat the fixing roller 351 in portions thereof located outside the inner core 381. Therefore, it is preferable to interrupt the magnetic path in the aforementioned regions between each end of the inner core 381 and the maximum sheet passing area.

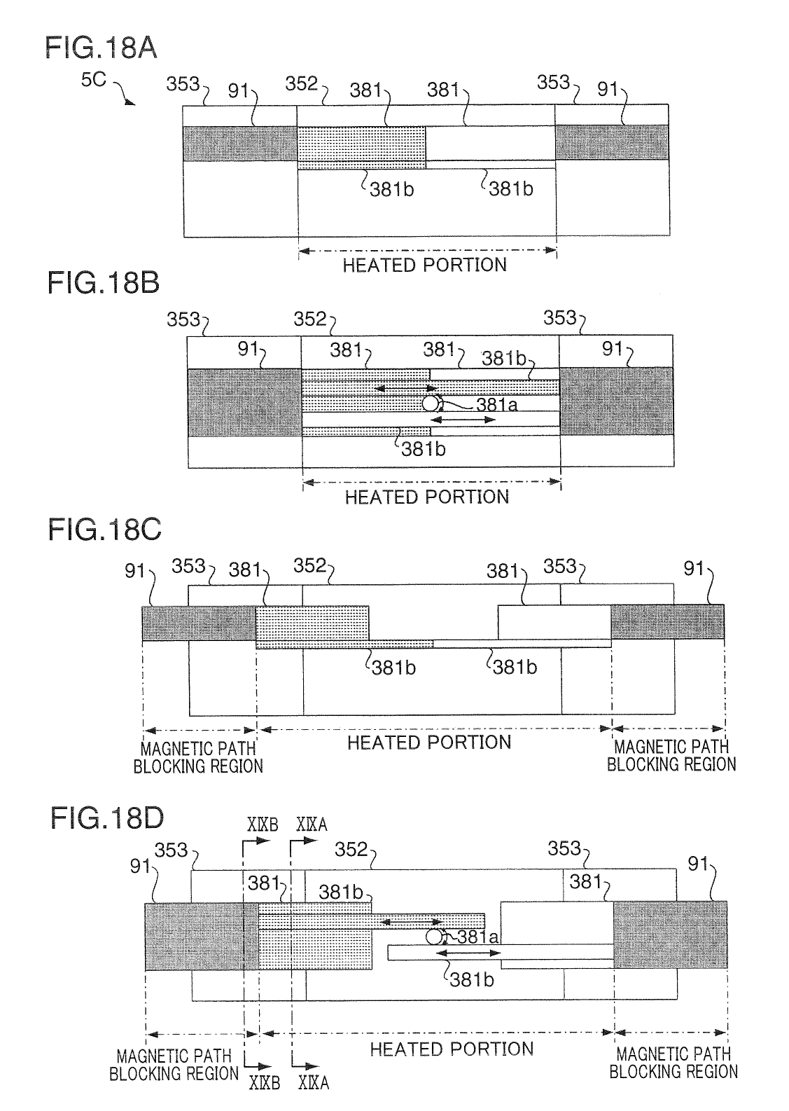

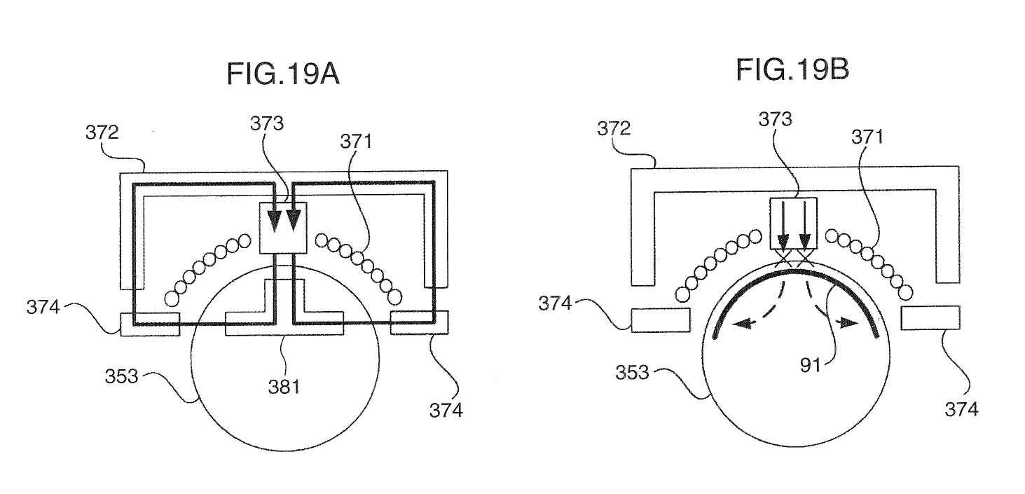

FIGS. 18A, 18B, 18C, 18D, 19A and 19B are schematic diagrams for explaining a fixing device 5C in one variation of the third embodiment. The fixing device 5C has a structure which makes it possible to interrupt the magnetic path outside the heated portion of the fixing roller 351 which can have such a length that corresponds to the width of any specified paper size. In these Figures, elements identical or similar to those of the above-described fixing device 5B are designated by the same reference symbols and a description of such elements is not given below.

FIGS. 18A, 18B, 18C and 18D are schematic diagrams for explaining the internal construction of the fixing roller 351 of the fixing device 5C, and FIGS. 19A and 19B are schematic cross-sectional diagrams for explaining the magnetic path formed in the fixing device 5C. FIGS. 18A and 18B show a state in which the heated portion of the fixing roller 351 is adjusted to match the minimum sheet passing area, and FIGS. 18C and 18D show a state in which the heated portion of the fixing roller 351 is adjusted to match a paper size (e.g., the A4 size) which is larger than the minimum sheet passing area. FIGS. 18A and 18C are diagrams showing the internal construction of the fixing roller 351 as viewed along a sheet passing direction of the fixing roller 351, and FIGS. 18B and 18D are diagrams showing the internal construction of the fixing roller 351 as viewed vertically upward. FIGS. 19A and 19B are cross-sectional diagrams taken along lines XIXA-XIXA and XIXB-XIXB of FIG. 18D, respectively.

The fixing device 5C includes a pair of shielding plates 91 (shields) which are provided at both outer ends of the two core segments of the inner core 381 along the axial direction of the fixing roller 351. These shielding plates 91 extend toward both ends of the maximum sheet passing area to interrupt the magnetic path in regions between each end of the inner core 381 and a corresponding end of the maximum sheet passing area. The shielding plates 91 are members made of copper or aluminum, for example, having an arc-shaped cross section which fits a curved inner surface of the fixing roller 351 as shown in FIG. 19B.

In the fixing device 5C thus configured, the shielding plates 91 move together with the core segments of the inner core 381, so that the fixing roller 351 is kept from being undesirably heated in such regions outside the heated portion of the fixing roller 351 that are determined in accordance with the paper size.

Specifically, when the heated portion of the fixing roller 351 is set to match the minimum sheet passing area as shown in FIGS. 18A and 18B, the shielding plates 91 exist in regions of the nonmagnetic roller elements 353 outside the magnetic roller element 352 between the second outer core section 373 and the inner core 381 and between the inner core 381 and the third outer core section 374 as shown in FIG. 19B. Since the magnetic path is interrupted by the shielding plates 91 in the regions outside the magnetic roller element 352 as a result, the nonmagnetic roller elements 353 are kept from being undesirably heated. If the fixing device 5C is not provided with the shielding plates 91, part of the magnetic flux routed from the second outer core section 373 returns to the third outer core section 374 in the regions outside the magnetic roller element 352 too as shown by broken lines in FIG. 19B, so that the fixing roller 351 may be undesirably heated in these regions.

On the other hand, when the heated portion of the fixing roller 351 is larger than the minimum sheet passing area as shown in FIGS. 18C and 18D, the magnetic path along which the magnetic flux generated by the induction coil 371 is guided is formed in regions where the core segments of the inner core 381 overlap the nonmagnetic roller elements 353 as shown by thick arrows in FIG. 19A. However, the shielding plates 91 exist between the second outer core section 373 and the inner core 381 and between the inner core 381 and the third outer core section 374 in the regions between each end of the inner core 381 and the corresponding end of the maximum sheet passing area in this case as shown in FIG. 19B. Consequently, the magnetic path is interrupted by the shielding plates 91 in regions outside the core segments of the inner core 381, thereby preventing the nonmagnetic roller elements 353 from being undesirably heated in the regions outside the core segments of the inner core 381.

While the invention has thus far been described with reference to the illustrative embodiments thereof, important arrangements and features of the invention can be summarized as follows.

According to one principal aspect of the invention, a fixing device comprises a heated member formed into a hollow, cylindrical shape, the heated member including a nonmagnetic portion having a particular length along an axial direction of the heated member, a magnetic flux generator for generating magnetic flux exerted on the heated member, a first magnetic core disposed face to face with the magnetic flux generator with the heated member positioned between the first magnetic core and the magnetic flux generator to form a magnetic circuit which is routed to come out of the magnetic flux generator, pass through the heated member and return to the magnetic flux generator, and a shifting mechanism for varying the length of an area of the heated member along the axial direction thereof where the nonmagnetic portion of the heated member and the first magnetic core face each other.

In this structure, the fixing device is provided with the shifting mechanism which makes it possible to freely vary the length of the area of the heated member where the nonmagnetic portion of the heated member and the first magnetic core face each other. Therefore, the fixing device can provide a high degree of freedom in adjusting the length of a heated portion of the heated member, making it possible to prevent overheating of each non-sheet passing area of the heated member in a reliable fashion.

Preferably, the aforementioned fixing device is configured such that the first magnetic core is disposed inside the heated member and the magnetic flux generator is disposed outside the heated member. In this structure, the first magnetic core is disposed by using an internal space of the heated member, so that the fixing device can be structured in a compact size.

Preferably, the magnetic flux generator includes an induction coil disposed face to face with an area of the heated member along the axial direction thereof corresponding to a maximum sheet passing width which is the width of the largest one of printing sheets passed through the fixing device. This arrangement serves to ensure that the magnetic flux generated by the induction coil acts on the heated member all across the maximum sheet passing area.

Also, it is preferable that the fixing device be configured such that the first magnetic core includes a first portion having a length corresponding to the maximum sheet passing width along the axial direction and a second portion having a length corresponding to a minimum sheet passing width which is the width of the smallest one of the printing sheets passed through the fixing device, the first and second portions of the first magnetic core being disposed inside the heated member, and the shifting mechanism shifts the first magnetic core between a first posture at which the first portion of the first magnetic core faces the heated member, serving to form the magnetic circuit, and a second posture at which the second portion of the first magnetic core faces the heated member, serving to form the magnetic circuit.

The fixing device thus configured makes it possible to adjust the length of the heated portion of the heated member according to printing sheets having the maximum sheet passing width and the minimum sheet passing width by simply shifting the first magnetic core between the first posture and the second posture.

Preferably, the fixing device is configured such that the first magnetic core is a member rotatable about an axis thereof further including an intermediate portion between the first and second portions of the first magnetic core, the intermediate portion continuously changing in length along the axial direction, and the shifting mechanism is a rotary driver for turning the first magnetic core about the axis thereof so that the first magnetic core assumes one of the first posture, the second posture and a third posture at which the intermediate portion of the first magnetic core faces the heated member, serving to form the magnetic circuit.

In this structure, it is possible to arbitrarily vary the length of the heated portion of the heated member by turning the first magnetic core by means of the aforementioned rotary driver, so that the fixing device can be adapted to printing sheets of various paper sizes.

It is also preferable that the fixing device further comprise a rotating angle controller for controlling the amount of rotation of the first magnetic core achieved by the rotary driver according to the size of each printing sheet passed through the fixing device. This arrangement makes it possible to automatically adjust the length of the heated portion of the heated member according to paper sizes and thus prevent overheating of end portions of the heated member.

Preferably, the aforementioned fixing device is configured such that the first magnetic core has a length corresponding to the maximum sheet passing width along the axial direction, and the shifting mechanism is a thrust driver for moving at least one of the magnetic flux generator and the first magnetic core along the axial direction. In this structure, it is possible to arbitrarily vary the length of the heated portion of the heated member by moving the first magnetic core along the axial direction by means of the aforementioned thrust driver, so that the fixing device can be adapted to printing sheets of various paper sizes.

It is also preferable that the fixing device further comprise a moving distance controller for controlling a moving distance of one of the magnetic flux generator and the first magnetic core achieved by the thrust driver according to the size of each printing sheet passed through the fixing device. This arrangement makes it possible to automatically adjust the length of the heated portion of the heated member according to paper sizes and thus prevent overheating of the end portions of the heated member.

Also, it is preferable that the fixing device be configured such that the thrust driver moves both of the magnetic flux generator and the first magnetic core by the same distance in opposite directions symmetrically with respect to a mid-length point of the heated member. This configuration is suitable for such a type of fixing device that a center line of each printing sheet passes the mid-length point of the heated member.

The aforementioned thrust driver may be configured with a rack supporting one of the magnetic flux generator and the first magnetic core and a pinion meshed with the rack.

Also, the fixing device may be configured such that the heated member includes a magnetic portion having a first width which is smaller than the maximum sheet passing width along the axial direction of the heated member and the aforementioned nonmagnetic portion having a second width, the sum of the first width and the second width equaling the maximum sheet passing width, and the shifting mechanism is a core moving mechanism for varying the length where the nonmagnetic portion thereof and the first magnetic core face each other by moving the first magnetic core along the axial direction.

In this configuration, the length of the heated portion of the heated member varies with the length of that portion of the first magnetic core which overlaps the nonmagnetic portion of the heated member. Thus, it is possible to arbitrarily vary the length of the heated portion of the heated member by changing the length of the area of the heated member where the nonmagnetic portion thereof faces the first magnetic core.

In this case, it is preferable that the fixing device be configured such that the magnetic portion of the heated member has a length along the axial direction corresponding to a minimum sheet passing width which is the width of the smallest one of the printing sheets passed through the fixing device. It is also preferable that the fixing device be configured such that the nonmagnetic portion of the heated member is provided at each axial end of the magnetic portion thereof. This structure makes it possible that the minimum sheet passing area is continuously heated while outside the minimum sheet passing area is only heated at the time when the sheet size requires to heat.

Preferably, the aforementioned fixing device further comprise a core position controller for moving the first magnetic core by controlling the core moving mechanism according to the size of each printing sheet passed through the fixing device so that at least one of the magnetic portion of the heated member and the first magnetic core is located in an area corresponding to the size of the printing sheet and the first magnetic core is not located outside the area corresponding to the size of the printing sheet.

This arrangement makes it possible to automatically adjust the length of the heated portion of the heated member according to paper sizes, obtain a specific fixing temperature in a sheet passing area and thus prevent overheating of each non-sheet passing area of the heated member.

It is also preferable that the fixing device further comprise shields disposed at both ends of the first magnetic core for interrupting the magnetic circuit. This arrangement makes it possible to block that part of the magnetic flux which leaks from outside the first magnetic core and thereby prevent undesirable overheating of the nonmagnetic portion of the heated member.

Still preferably, the magnetic flux generator includes a second magnetic core for guiding the magnetic flux generated by the induction coil to the first magnetic core. This makes it possible to guide the magnetic flux to the first magnetic core in a desirable fashion by properly locating the second magnetic core.

Yet preferably, the second magnetic core is disposed outside the heated member with the induction coil positioned between the second magnetic core and the heated member. This arrangement of the second magnetic core makes it possible to easily form a magnetic circuit which passes through the heated member.

This application is based on Japanese Patent Application Nos. 2008-142659, 2008-152408, 2008-146670 filed on May 30, 2008, Jun. 11, 2008 and Jun. 4, 2008 the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A fixing device comprising:
a heated member formed into a hollow, cylindrical shape, said heated member including a nonmagnetic portion having a particular length along an axial direction of said heated member;
a magnetic flux generator for generating magnetic flux exerted on said heated member;
a first magnetic core disposed face to face with said magnetic flux generator with said heated member positioned between said first magnetic core and said magnetic flux generator to form a magnetic circuit which is routed to come out of said magnetic flux generator, pass through said heated member and return to said magnetic flux generator; and
a shifting mechanism for varying the length of an area of said heated member along the axial direction thereof where the nonmagnetic portion of said heated member and said first magnetic core face each other.

2. The fixing device according to claim 1, wherein said first magnetic core is disposed inside said heated member, and said magnetic flux generator is disposed outside said heated member.

3. The fixing device according to claim 2, wherein said magnetic flux generator includes an induction coil disposed face to face with an area of said heated member along the axial direction thereof corresponding to a maximum sheet passing width which is the width of the largest one of printing sheets passed through said fixing device.

4. The fixing device according to claim 3, wherein said first magnetic core includes a first portion having a length corresponding to the maximum sheet passing width along the axial direction and a second portion having a length corresponding to a minimum sheet passing width which is the width of the smallest one of the printing sheets passed through said fixing device, the first and second portions of said first magnetic core being disposed inside said heated member, and said shifting mechanism shifts said first magnetic core between a first posture at which the first portion of said first magnetic core faces said heated member, serving to form the magnetic circuit, and a second posture at which the second portion of said first magnetic core faces said heated member, serving to form the magnetic circuit.

5. The fixing device according to claim 4, wherein said first magnetic core is a member rotatable about an axis thereof further including an intermediate portion between the first and second portions of said first magnetic core, the intermediate portion continuously changing in length along the axial direction, and said shifting mechanism is a rotary driver for turning said first magnetic core about the axis thereof so that said first magnetic core assumes one of the first posture, the second posture and a third posture at which the intermediate portion of said first magnetic core faces said heated member, serving to form the magnetic circuit.

6. The fixing device according to claim 5 further comprising a rotating angle controller for controlling the amount of rotation of said first magnetic core achieved by said rotary driver according to the size of each printing sheet passed through said fixing device.

7. The fixing device according to claim 3, wherein said first magnetic core has a length corresponding to the maximum sheet passing width along the axial direction, and said shifting mechanism is a thrust driver for moving at least one of said magnetic flux generator and said first magnetic core along the axial direction.

8. The fixing device according to claim 7 further comprising a moving distance controller for controlling a moving distance of one of said magnetic flux generator and said first magnetic core achieved by said thrust driver according to the size of each printing sheet passed through said fixing device.

9. The fixing device according to claim 7, wherein said thrust driver moves both of said magnetic flux generator and said first magnetic core by the same distance in opposite directions symmetrically with respect to a mid-length point of said heated member.

10. The fixing device according to claim 7, wherein said thrust driver includes a rack supporting one of said magnetic flux generator and said first magnetic core and a pinion meshed with the rack.

11. The fixing device according to claim 3, wherein said heated member includes a magnetic portion having a first width which is smaller than the maximum sheet passing width along the axial direction of said heated member and said nonmagnetic portion having a second width, the sum of the first width and the second width equaling the maximum sheet passing width, and said shifting mechanism is a core moving mechanism for varying the length where the nonmagnetic portion thereof and said first magnetic core face each other by moving said first magnetic core along the axial direction.

12. The fixing device according to claim 11, wherein the magnetic portion of said heated member has a length along the axial direction corresponding to a minimum sheet passing width which is the width of the smallest one of the printing sheets passed through said fixing device.

13. The fixing device according to claim 12, wherein the nonmagnetic portion of said heated member is provided at each axial end of the magnetic portion thereof.

14. The fixing device according to claim 11 further comprising a core position controller for moving said first magnetic core by controlling said core moving mechanism according to the size of each printing sheet passed through said fixing device so that at least one of the magnetic portion of said heated member and said first magnetic core is located in an area corresponding to the size of the printing sheet and said first magnetic core is not located outside the area corresponding to the size of the printing sheet.

15. The fixing device according to claim 11 further comprising shields disposed at both ends of said first magnetic core for interrupting the magnetic circuit.

16. The fixing device according to claim 3, wherein said magnetic flux generator includes a second magnetic core for guiding the magnetic flux generated by said induction coil to said first magnetic core.

17. The fixing device according to claim 16, wherein said second magnetic core is disposed outside said heated member with said induction coil positioned between said second magnetic core and said heated member.

18. An image forming apparatus comprising:
an image forming device for transferring a toner image to a printing sheet; and
a fixing device for fixing the toner image to the printing sheet, said fixing device including:
a heated member formed into a hollow, cylindrical shapes said heated member including a nonmagnetic portion having a particular length along an axial direction of said heated member;
a magnetic flux generator for generating magnetic flux exerted on said heated member;
a first magnetic core disposed face to face with said magnetic flux generator with said heated member positioned between said first magnetic core and said magnetic flux generator to form a magnetic circuit which is routed to come out of said magnetic flux generator, pass through said heated member and return to said magnetic flux generator; and
a shifting mechanism for varying the length of an area of said heated member along the axial direction thereof where the nonmagnetic portion of said heated member and said first magnetic core face each other.
